(19) United States
(12) Patent Application Publication
(10) Pub. No.: US 2004/0133447 A1
(43) Pub. Date: Jul. 8, 2004

(54) Method and system for sales process integration

(76) Inventor: Prasad Boppana, Houston, TX (US)

Correspondence Address: MCANDREWS HELD & MALLOY, LTD, 500 WEST MADISON STREET, SUITE 3400, CHICAGO, IL, 60661

(21) Appl. No.: 10/716,290

(22) Filed: Nov. 18, 2003

Related U.S. Application Data
(60) Provisional application No. 60/427,397, filed on Nov. 19, 2002.

(51) Int. Cl. G06F 17/60

(52) U.S. Cl. 705/1

(57) ABSTRACT

Certain embodiments of the invention may be found in a method and system for sales process integration. Aspects of the invention may comprise connecting one or more sales processes having at least one of a plurality of contexts to one or more external processing resources. The contexts may comprise, for example, offer, vertical, channel, geography and customer. Notwithstanding, sales process related information may be acquired from one or more of the external processing resources and the acquired sales process related information may be processed. Resulting sales process related information may then be communicated to one or more of the sales processes. Acquiring sales process related information may occur in real-time or at a time subsequent to connecting one or more of the sales processes. Additionally the sales process integration may also include managing communication between one or more sales processes and one or more external processing resources.

### CROSS-REFERENCE TO RELATED APPLICATIONS/INCORPORATION BY REFERENCE

This application makes reference to, claims priority to and claims the benefit of U.S. Provisional Application Serial No. 60/427,397 (Attorney Docket No. 14136US01) filed on Nov. 19, 2002.

This application also makes reference to:

U.S. Provisional Application Serial No. 60/427,588 (Attorney Docket No. 14132US01) filed on Nov. 19, 2002;

U.S. Provisional Application Serial No. 60/427,602 (Attorney Docket No. 14133US01) filed on Nov. 19, 2002; and

U.S. Provisional Application Serial No. 60/427,582 (Attorney Docket No. 14137US01) filed on Nov. 19, 2002.

All of the above stated applications are hereby incorporated herein by reference in their entirety.

### FIELD OF THE INVENTION

Certain embodiments of the invention relate to sales automation in a business environment. More specifically, certain embodiments of the invention relate to a method and system for sales process integration.

### BACKGROUND OF THE INVENTION

The pervasiveness of information technologies along with data transfer media such as the Internet, have provided an excellent opportunity for customers to tap into a diverse range of services and products and for businesses to provide the necessary products and services to meet customer demands. In this regard, e-business and e-commerce solutions have revolutionized business practices over the past few decades. Notwithstanding, the advantages provided by e-business, e-commerce and various other related information methodologies and technologies, there is a general lack of consolidated sales process information.

In general, sales process information may encompass any information and/or tasks that are required to identify customer needs, up to and including any information and/or tasks necessary to consummate a sale. For example, sales process information may include information such as customer needs, customer requirements, customer business and financial data, and past and present customer practices. Current sales paradigms require sellers to access a myriad of systems in order to acquire necessary sales process information to satisfy their business requirements.

A “seller” may refer to an entity sourcing goods and/or services, while a “buyer” may be any entity that receives good and/or services from, for example, a “seller.” Accordingly, depending on which entity is sourcing goods or services in a particular transaction, an entity may be a “seller” in one transaction but be a “buyer” in a subsequent transaction. Similarly, depending on which entity is receiving goods and/or services in a particular transaction, an entity may be “buyer” in a particular transaction, and a “seller” in a subsequent transaction. Additionally, a similar definition may apply to a customer depending on whether a customer is receiving goods and/or services, or sourcing goods and/or services.

Lack of consolidated information can be burdensome to companies. The general lack of consolidated information means that sellers typically have to access and/or acquire information from, for example, a plurality of vendor databases. These databases may be hosted by a plurality of disparate systems, and often require various access interfaces and/or methodologies. In certain instances, specialized hardware and/or software may be required. In this regard, depending on information complexity, location and volume, a seller may require specialized knowledge and training to access multiple systems in order to acquire relevant sales process information necessary to sell its products and/or services. In many instances, a large portion of the acquired sales process information may be irrelevant to the context of the seller's requirements, and hence unusable. Additionally, since sales process information may be stored in various disparate repositories, integration of information may be difficult and in certain cases, may not be readily accessible. Accordingly, not only is the accessibility of information difficult, but general availability and discovery of information may also be severely impacted.

In particular, in certain instances, additional workers beyond the salesperson are often required to identify and/or locate pertinent information. This can significantly increase time-to-market and/or product cost. The current sales paradigm is not only inefficient, but may often prove to be quite costly since vast amounts of time may be spent searching for pertinent sales process information.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

Certain embodiments of the invention may be found in a method and system for sales process integration. Aspects of the method may comprise communicating data representative of at least one sales process having at least one of a plurality of contexts to one or more external processing resources. The context may comprise offer, channel, vertical, geography, and customer. Notwithstanding, the sales process related information may be acquired from one or more of the external processing resources and the acquired sales process related information may be processed. The sales process related information that has been processed may then be communicated to one or more of the sales processes. The acquiring of sales process related information may be adapted to occur in real-time or at a time subsequent to connecting one or more of the sales processes. Communication between one or more sales processes and/or one or more external processing resources may also be managed.

The processing of sales process related information may further comprise synchronizing sales process related information transfer between one or more sales processes and one or more external processing resources. The synchronizing may further include translating sales process related information from a first non-native format to a second native format, and vice versa, and validating the translated sales process related information. The validated sales processing related information may be staged and referenced to determine any appropriate sales process related information associations.

The method for sales process integration may further include scheduling the processing of acquired sales process related information. The scheduling step may further include controlling at least a frequency of acquiring sales process related information from one or more of the external processing resources. The processing step may also include detecting operational errors, notifying one or more sub-systems and/or one or more system operators of any detected operational error. In one aspect of the invention, the operational errors may be configured so that they may have a plurality of severity levels.

The method for sales process integration may further include configuring operations of the connecting, acquiring, processing, and communicating steps. In this regard, the sales process integration may be tailored to operate in one of a plurality of operational modes and/or under a plurality of conditions using various parameters. The external processing resource may comprise SAP, order management system (ODM), customer relationship management (CRM), document management system (DMS), learning management system (LMS) and lightweight directory access (LDAP) system.

Another aspect of the invention also provide a machine readable storage, having stored thereon a computer program having at least one code section for sales process integration. The at least one code section may be executable by a machine for causing the machine to perform the steps as described above for sales process integration.

Aspects of the system for sales process integration may comprise a sales process integration engine which may include, for example, an integration configurator, a data synchronizer coupled to the integration configurator, a service scheduler coupled to the integration configurator and a service notifier coupled to the integration configurator. The data synchronizer may further include an integration communication interface, a data mapper coupled to the integration communication interface, a data validator coupled to the integration communication interface and a data stager coupled to the integration communication interface.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram of a sales processing system having an exemplary sales integration engine in accordance with an embodiment of the invention.

FIG. 1a is a block diagram of an exemplary data synchronization block in accordance with an embodiment of the invention.

FIG. 2 is a block diagram of an exemplary sales process in accordance with an embodiment of the invention.

FIG. 3 is a block diagram illustrating exemplary steps for sales process integration in accordance with an embodiment of the invention.

### DETAILED DESCRIPTION OF THE INVENTION

Certain aspects of the invention relate to a method and system for a sales integration engine. An aspect of the invention provides a single consolidated location where sellers may access and acquire sales data and information pertaining to working opportunities initialized to sell its product offerings. Products may include, but are not limited to, goods, whether tangible or intangible, and services. An aspect of the invention may also provide real time links between any number of sales processes and external systems which receive and/or distribute sales process information. The sales process information may provide business opportunities and may include any information that may be pertinent to creating and maintaining a relationship between a customer or potential customer and a business. Sales processes information may be classified into a plurality of categories or contexts, which may include, but are not limited to, product offering data, channel data, vertical data, geographical data and customer data. An embodiment of the invention provides a sales integration engine which may eliminate, for example, many of the complexities and time required for connecting and interfacing with myriad external systems.

Sales processes may form the backbone for a seller's activities while working on opportunities to sell product offerings. Sales processes may be modeled to simulate various phases of a sales process selling cycle. These phases may include, but are not limited to, customer needs identification, decision making identification, product and/or service demonstration and return on investment. Each phase may include a series of activities that may have to be completed in order to progress through the sales process selling cycle. In some instances, one or more of the activities in a sales process selling cycle may require certain pre-conditions or contents be fulfilled before an activity may be completed. Information needed to complete an activity or to satisfy a pre-condition may vary depending on a number of parameters. In an exemplary case where an return on investment (ROI) analysis task is required, some of these parameters may include, but are not limited to, one or more base documents that may be required to create the ROI and the revenue generated over the last fiscal year and/or last quarter. Similarly, exemplary activities may include, but are not limited to, collection of revenue information, illustration of earnings growth and determination of investment growth. Accordingly, aspects of the invention provide a system and method for efficiently fulfilling pre-conditions and activities that may be necessary for completing a sales process selling cycle.

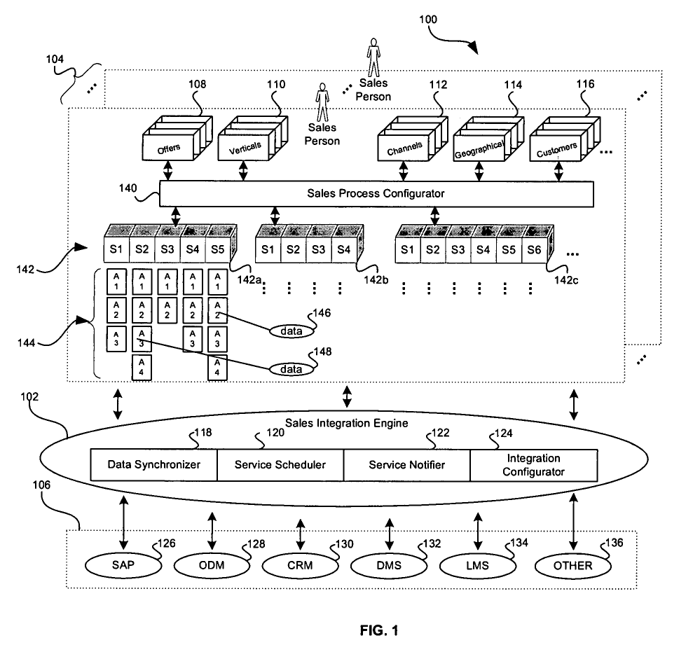

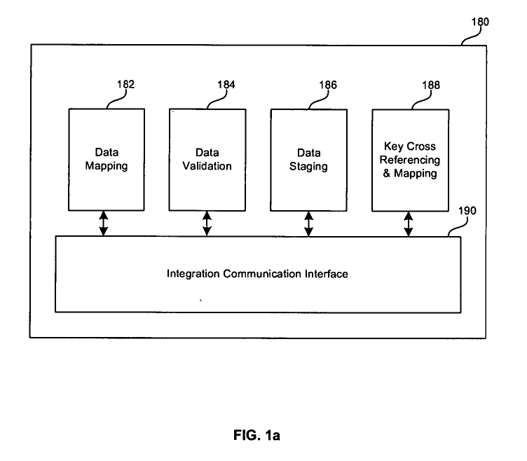

FIG. 1 is a block diagram of sales processing system 100 having an exemplary sales integration engine block 102 in accordance with an embodiment of the invention. Referring to FIG. 1, there is shown a sales integration engine or block 102, customer opportunities and data blocks collectively referred to as 104, and an information resources block 106.

The sales integration engine 102 may be adapted to connect the activities from any number of processes in any context, to any external system, and to send, receive and process sales process information in real time and/or or at some time subsequent to the acquisition of the sales process information. The sales integration engine 102 may be based on a sales integration framework, which may contain a plurality of sub-components, which may be adapted to provide one or more services necessary to connect to and manage data exchange between one or more sales processes and one or more external systems. Since sales process information required by sellers to access working opportunities in order to sell product offerings may be made available or accessible in one consolidated location, the sales integration engine 102 may remove the complexities and time required for connecting and interfacing with the external systems.

The sales integration engine or block 102 may include a plurality of functional blocks, each of which may be adapted to perform specialized data processing tasks. The exemplary sales integration engine or block 102 of FIG. 1 may include any one or more of a data synchronization block or engine 118, a service scheduler block 120, a service notification block 122, and an integration configurator block 124. In accordance with an embodiment of the invention, the data synchronization block 118 may be adapted to include at least one or more of a data mapping function, a data validation function, a data staging function, a key cross referencing and mapping function, and an integration communication interface that may permit communication with external systems.

FIG. 1a is a block diagram of an exemplary data synchronization block 118 in accordance with an embodiment of the invention. Referring to FIG. 1a, there is shown a data mapping function 182, a data validation function 184, a data staging function 186, a key cross referencing and mapping function 188, and an integration communication interface 190.

The data mapping function 182 of the data synchronization block 118 may be adapted to translate information from a first non-native format to a second format, the latter of which may be interpreted by the sales processing system. In this regard, the data mapping function 182 may include one or more mappers or translators that may be configured to convert information from various non-native formats to a format native to the sales processing system. For example, the data mapping function 182 may be adapted to convert hypertext markup language (HTML) formatted information into extensible markup language (XML) formatted information.

The data validation function 184 of the data synchronization block 118 may be adapted to validate information that has been processed or translated by the mapping function. The data validation function 184 may verify the integrity of the translated information to ensure its accuracy and consistency.

The data staging function 186 of the data synchronization block 118 may include one or more quality approval processes. In one embodiment of the invention, a quality approval process may be adapted to determine whether the information meets certain criteria and/or guidelines. The criteria and/or guidelines may be company based, standards based, industry based, de facto, and/or government based. For example, the quality approval process may ensure that company guidelines have been followed and that standardized processes and procedures such as ISO 9001 have been satisfied.

The key cross referencing and mapping function 188 of the data synchronization block 118 may be adapted to maintain a unique key cross-referencing between external systems and an internal sales processing system. In this regard, subsequent to the synchronization of information by the data synchronization block 118, the key cross referencing and mapping function 188 may be adapted to evaluate the data and determine possible associations that may inter-relate at least portions of the synchronized information.

The integration communication interface 190 of the data synchronization block 118 may be adapted to facilitate communication with one or more of a plurality of disparate and/or external systems. In this regard, the integration communication interface 190 may be adapted to communicate with, for example, an enterprise application integration (EAI) system or server. In a accordance with an aspect of the invention, middleware may be utilized to integrate various application programs to ensure that information may be readily interchanged between, for example, databases, legacy systems and disparate systems that my contain relevant sales process data or information.

In a case where it may be necessary to determine whether a particular candidate may be qualified for particular job, the data mapping function 184 may be adapted to select an appropriate candidate from a plurality of candidates. The data validation function 184 may determine whether the candidate has the required qualifications, which may include academic and/or employment experience. The data staging function 186 may determine whether the credentials stated by the candidate are in fact genuine. Subsequent to synchronization of the information, the key cross referencing and mapping function 188 may be adapted to determine how the credentials of the candidate compares to other candidates that might have been hired in the past. In another example, the key mapping and cross referencing 188 function may be adapted to determine how the credentials of the candidate compares to other similar candidates hired by external companies.

The sales integration engine 102 may also include a service scheduler block 120. Since the sales integration engine 102 may communicate with a plurality of other information systems, the service scheduler block 120 may be adapted to control a frequency at which the sales integration engine 102 my acquire and/or update information. For example, the service scheduler 120 may be adapted to query a particular customer information database at intervals, which may include, but are not limited to, every microsecond, every minute, every hour, once per day, once per week or at the end of every month.

In an embodiment of the invention, a frequency at which the service integration engine 102 may acquire updates may be adaptively altered by the service scheduler 120. Accordingly, the service scheduler 120 may be adaptively configured to instruct the sales integration engine 102 to obtain updates from certain databases or information systems in real time. For example, the CRM block 130 in the information resources block 106 may be known to continually update its customer database throughout the day while customers call into a CRM call center. With this knowledge, the service scheduler 120 may be adapted to schedule the sales integration engine 102 to acquire information from the CRM block 130 at a frequency of, for example, every ten (10) minutes. In a case where the CRM block 130 may be known to update its customer database only at the close of business during the week, then the service scheduler 120 may be adapted to schedule the sales integration engine 102 to acquire information at midnight every day during the week.

The sales integration engine 102 may also include a service notifier block 122. Since the sales integration engine 102 communicates with a plurality of other systems, the service notifier 122 may oversee the operations of the sales integration engine to determine whether any errors occur in the operations of the sales integration engine 102. The service notifier 122 may be adapted to detect errors in the operations of the sales integration engine 102 without a need for manual intervention. However, the invention may not be limited in this regard and the service notifier block 122 may require manual intervention in certain circumstances.

In one aspect of the invention depending on the type of business entity, various levels of severity of the errors may be defined. The type of business entity may include, but is not limited to, customer information, opportunity information and content related information. A content related business entity may have, for example, ten (10) severity levels, namely severity level one (1) through severity level ten (10). In this regard, severity level one (1) may be the least severe error and severity level ten (10) may refer to the most severe error. In one embodiment of the invention, depending on the level of severity specific, notifications may be dispatched to selected sub-subsystems and/or persons.

The sales integration engine 102 may also include an integration configurator 124. In general, the sales integration engine 102 may be designed to be highly configurable. In this regard, the integration configurator 124 facilitates speedy configuration of the sales integration engine 102 to meet the requirements of a particular business application. The integration configurator 124 may include one or more graphical user interfaces (GUIs) that may run on a terminal directly or remotely coupled to the sales processing system. The GUI may provide selectable options that permit the selection of various parameters that may permit one or more of a plurality of operational modes for the sales integration engine 102. The GUI may also permit input of certain parameters that may affect the operation of the sales integration engine 102.

The integration configurator 124 may be configured to permit the sales integration engine 102 to interact with a plurality of systems without the need to engage in software modification. Once new parameters are entered into the integration configurator 124, the data synchronizer 118 may accordingly change the operations of the sales integration engine 102 to operate with the new parameters. Notably, whenever it may be desirable to make changes to the operations of the sales integration engine 102, these changes may be made via the integration configurator 124. For example, in a case where specialized data may be received from specific ones of a plurality of information systems, the integration configurator 124 may instruct the sales integration engine 102 to acquire information from only those specified information systems.

In certain instances, it may be necessary to orchestrate the sequencing of data from a plurality of information systems. In a case where it may be appropriate to receive data from particular ones of the plurality of information systems prior to receiving data from other ones of the information systems, the integration configurator 124 may be configured to provide the appropriate sequence in which the data should be received. In another aspect of the invention, the integration configurator 124 configures how data may be received and processed. In this case, the integration configurator 124 may configure the sale integration engine 102 to receive incremental changes to a customer record or receive the complete customer record whenever a change has occurred in a customer record. The integration configurator 124 may also be adapted for load balancing of the sales processing system. This may permit changes that dictate where and how particular sales process information may be processed within the system. In order to balance system load, the integration configurator 124 may also be configured to prioritize the execution of certain sales processes. The integration configurator 124 may also be programmed to determine a number of subscribers to which data may be sent and also a number of systems from which data may be received. Furthermore, in another aspect of the invention, metadata required for the data synchronizer to execute its data mapping or translation function may also be stipulated by the integration configurator 124. In this regard, the integration configurator 124 may specify what languages may be necessary for proper translation and mapping.

The customer opportunities and data block 104 may include a sales process configurator 140 and any one or more of a product offerings data block 108, a verticals data block 110, a channels data block 112, a geographical data block 114 and a customers data block 116. The customer opportunities and data block 104 may further include a plurality of sales processes or tasks 142a, 142b, 142c, collectively illustrated as 142. Each of the tasks may have a plurality of steps. For example, sales process or task 142a may include five (5) steps, namely S1, S2, S3, S4, S5. Each of the steps may also include a plurality of activities collectively illustrated as 144. For example, step S1 has activities A1, A2 and A3. At least some of the activities may have pre-requisites or required contents 146, 148.

The information resources block 106 may include, for example, one or more of a SAP block 126, an order management system (ODM) block 128, a customer relationship management (CRM) block 130, a document management system (DMS) block 132, a learning management system (LMS) block 134 and/or other resource block 136. For example, the other resource block 136 may be a lightweight directory access (LDAP) database.

The SAP block 126 may be an information database that may be adapted to store and process SAP database related information. The order management system block 128 may be adapted to store product order information. The CRM block 130 may include a suite of products that may be integrated to provide the necessary infrastructure for implementing a channel for supporting sales process related activities. The CRM block 130 may be adapted to acquire, identify and retain customers. The document management system block 132 may be adapted to store and process sales documents. The learning management system block 134 may be adapted to function as a library system that may contain archived and historical information related to previous sales process transactions.

In the embodiment of the FIG. 1, the sales integration engine or block 102 may include a plurality of interfaces, at least one which may be coupled to the customer opportunities and data block 104 and another of which may be coupled to the information resources block 106. The sales integration engine or block 102 may be configured to potentially connect any number of sales processes to any one or more of a plurality of external systems, which may contain information required by sellers. Information acquired from the external systems may be relevant to at least one or more of the various data contexts which may be included in the customer opportunities and data block 104, for example product offerings data block 108, verticals data block 110, channels data block 112, geographical data block 114 and customer data block 116. The external systems, may be for example, one or more external servers and/or databases which may store and/or distribute information. The sales integration engine or block 102 may be configured to connect with a plurality of external information systems. In one embodiment of the invention, the information exchange may occur in real time as changes to data occur.

The offers block 108, verticals block 110, channels block 112, geographical block 114 and customers block 116 may be classified as contexts within the customer opportunities and data block 104. The product offering data block 108 may include, but is not limited to, information such as product and/or service descriptions. A channel may be a particular communication medium or a logical medium that may be used to offer one or more sales activities. The channel context block 112 may define a manner in which a business caters to its customers. This may include, but is not limited to, a telephone based channel, a web based channel, a kiosk based channel, a field based channel, a storefront channel and/or mail order based channel.

In general, the verticals block 110 may refer to the different types of businesses and/or industries to which a particular business may cater. For example, an equipment manufacturer may cater to verticals including, finance, manufacturing, resellers, legal, and retail. The customer context block 116 may define the spectrum of actual and potential customers. The geographical context may include information pertaining to the location of a customer. Additionally, the geographical context may also include information pertaining to customer demographics.

The customer opportunities and data block 104 may include various sales processes or tasks 144, each of which may have a number of steps. For example, sales process or task 142a is shown having five steps, namely S1, S2, S3, S4, S5. Step S1 of sales process 142a has three (3) activities, namely A1, A2, A3. Step S2 of sales process 142a has four (4) activities, namely A1, A2, A3, A4. Step S3 of sales process 142a has two (2) activities, namely A1, A2. Step S4 of sales process 142a has three (3) activities, namely A1, A2, A3. Finally, step S5 of sales process 142a has four (4) activities, namely A1, A2, A3, A4. Activity A3 of step S2 requires prerequisite data or content 148 and activity A2 of step S5 requires prerequisite data 146. Accordingly, the prerequisite data or content 148 may be required for the completion of activity A3. Similarly, the prerequisite data or content 146 may be required for the completion of activity A2. Each of the activities for a particular task may require information from an external information system. The required information may be external to the sales integration system 102. In accordance with the invention, a collection of steps and activities and any perquisite data or content may form a sales process.

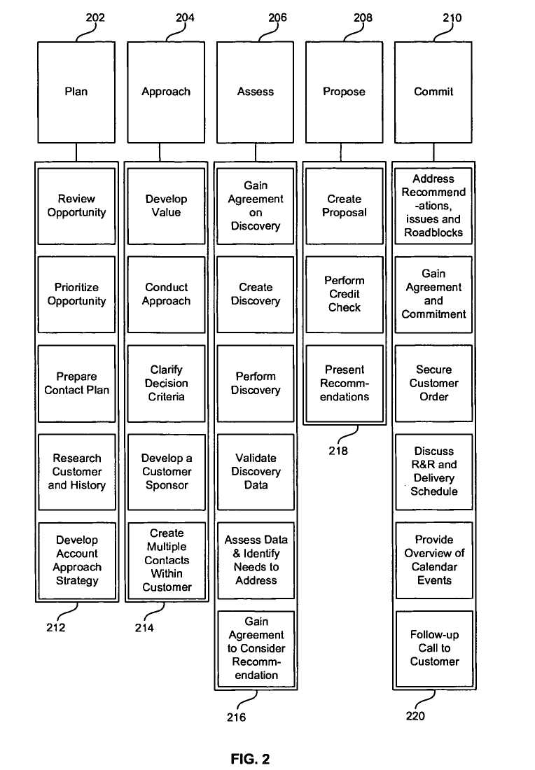

FIG. 2 is a block diagram of an exemplary sales process in accordance with an embodiment of the invention. Referring to FIG. 2, there is shown a plurality of steps, namely plan step 202, approach step 204, assess step 206, propose step 208 and commit step 210. Each of steps 202, 204, 206, 208, 210 may include one or more activities.

The plan step 202 may have five (5) activities, collectively referenced as 212. These activities 212 may include a review opportunity activity, prioritize opportunity activity, a prepare contact plan activity, a research customer and history activity and finally, a develop account approach strategy. The review opportunity activity may include a review of some or all the relevant issues related to the sales opportunity. The prioritize opportunity activity may include prioritizing the relevant issues and task involved with the sales opportunity. The prepare contact plan activity may include preparing a list of possible contacts and the roles and extent to which each contact might be involved. The research customer and history activity may include doing various searches in order to acquire information that may provide a synopsis of the company, including its history and performance. Varying levels of searching may be done depending on the depth and breadth of the information required. The develop account approach strategy activity may include developing a feasible account approach strategy.

The approach step 204 may have five (5) activities, collectively referenced as 214. These activities 214 may include a develop value activity, a conduct approach activity, a clarify decision criteria activity, a develop a customer sponsor activity and finally, a create multiple contacts within customer activity. The develop value activity may include creating a strategy on how best to approach a customer and how best to deliver a plan to the customer. The conduct approach activity may include strategizing how best to build customer awareness and stimulate a customer's interest. The develop customer sponsor activity may include the development of a sponsor's efforts within a customer's environment to support sales related activities. The create multiple contacts within customer activity may include ascertaining which contacts within, for example a company, may be beneficial to the sales opportunity.

The assess step 206 may have six (6) activities, collectively referenced as 216. These activities 216 may include a gain agreement on discovery activity, a create discovery activity, a perform discovery activity, a validate discovery activity, an assess data and identify need to address activity and finally, a gain agreement to consider recommendation activity. The gain agreement on discovery activity may include determining the scope and nature of the agreement and the parties and/or entities that may be involved in any agreement effort. The create discovery activity may include, for example, the creation of a questionnaire. The validate discovery data activity may include the step of validating and verifying the content of any material discovered. Since the perform discovery activity may be a critical activity to the assess step 206, the perform discovery activity may be denoted as a mandatory activity. The assess data and identify need to address activity may include identifying customer needs and formulating how best to satisfy those needs. The gain agreement to consider recommendation activity may include gaining agreement on acceptance of any recommendations that may be made.

The propose step 208 may have three (3) activities, collectively referenced as 218. These activities 218 may include a create proposal activity, a perform credit check activity, and finally, a present recommendations activity. The create proposal activity may include the creation of various proposals and recommendations pertinent to the sales strategy. Since the perform credit check activity may be a critical activity to the propose step 208, the perform credit check activity may be denoted as a mandatory activity. The present recommendations activity may include the presentation of recommendations to key decision makers and players related to the sales opportunity and/or activity.

The commit step 210 may have six (6) activities, collectively referenced as 220. These activities 220 may include an address recommendations, issues and roadblocks activity, a gain agreement and commitment activity, a secure customer order activity, a discuss recommendations, road blocks and delivery schedule activity, a provide overview of calendar events activity and finally, a follow-up call to customer activity. The address recommendations, issues and roadblocks activity may include deciding how best to handle roadblocks that have been encountered or may be encountered. The gain agreement on discovery activity may include finalizing the scope and nature of the agreement with the parties and/or entities involved in the agreement effort. The secure customer order activity may include acquiring an order for certain products and/or services from the customer. The discuss recommendations, road blocks and delivery schedule my include discussing any roadblocks that may be encountered or will be encountered during delivery of the product and/or service. The provide overview of calendar events activity may include creating a timeline of the events related to the sales process. For example, a timeline may be created to track the deliverables. Since the follow-up call activity may be a critical activity to the commit step 210, the follow-up call to customer activity may be denoted as a mandatory activity.

In operation, the sales integration engine 102 may, within the contexts of offers 108, verticals 110, channels 112, geographical 114 and customers 116, for a specific sales process, and/or for a particular activity within the sales process, acquire pertinent information from a resource in the information resources block 106 in real time.

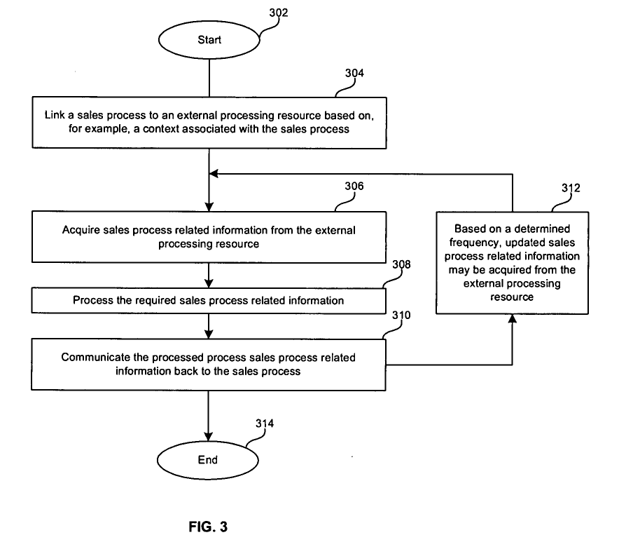

FIG. 3 is a block diagram illustrating exemplary steps for sales process integration in accordance with an embodiment of the invention. Referring to FIG. 3, the exemplary steps may start with step 302. Subsequently, in step 304, a sales process may be linked to an external processing resource based on, for example, a context associated with the sales process. In step 306, sales process related information may be acquired from the external processing resource. In step 308, the acquired sales process information may be processed. In step 310, the processed sales process related information may be communicated back to the sales process. Subsequent to step 310, the exemplary steps may end with step 314. Notwithstanding, subsequent to step 314, in step 312, based upon a determined frequency, updated sales process related information may be acquired from the external processing resource. Accordingly, step 306 may be executed after step 312.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for sales process integration, the method comprising:
communicating data representative of at least one sales process having at least one of a plurality of contexts to at least one external processing resource;
acquiring sales process related information from said at least one external processing resource;
processing said acquired sales process related information; and
communicating said processed sales process related information to said at least one sales process.

2. The method according to claim 1, wherein said acquiring sales process related information occurs in one of real-time and at a time subsequent to said connecting at least one sales process.

3. The method according to claim 1, further comprising managing communication between said at least one sales process and said at least one external processing resource.

4. The method according to claim 1, wherein said processing further comprises synchronizing said sales process related information transfer between said at least one sales process and said at least one external processing resource.

5. The method according to claim 4, wherein said synchronizing further comprises:
translating sales process related information from a first non-native format to a second native format;
validating said translated sales process related information;
staging said validated sales process related information; and
referencing said validated sales process related information to determine associations.

6. The method according to claim 1, further comprising scheduling said processing of said acquired sales process related information.

7. The method according to claim 6, wherein said scheduling further comprises controlling at least a frequency of said acquiring sales process related information from said at least one external processing resource.

8. The method according to claim 1, wherein said processing of said acquired sales process related information further comprises:
detecting operational errors; and
notifying at least one of a sub-system and a system operator of said detected error.

9. The method according to claim 8, wherein said detected operational errors comprises a plurality of severity levels.

10. The method according to claim 1, further comprising configuring operations of at least one of said connecting, acquiring, processing, and said communicating steps.

11. The method according to claim 1, wherein said external processing resource comprises at least one of SAP, order management system (ODM), customer relationship management (CRM), document management system (DMS), learning management system (LMS) and lightweight directory access (LDAP) system.

12. A machine readable storage, having stored thereon a computer program having at least one code section for sales process integration, the at least one code section executable by a machine for causing the machine to perform the steps comprising:
communicating data representative of at least one sales process having at least one of a plurality of contexts to at least one external processing resource;
acquiring sales process related information from said at least one external processing resource;
processing said acquired sales process related information; and
communicating said processed sales process related information to said at least one sales process.

13. The machine readable storage according to claim 12, wherein said acquiring sales process related information occurs in one of real-time and at a time subsequent to said connecting at least one sales process.

14. The machine readable storage according to claim 12, further comprising managing communication between said at least one sales process and said at least one external processing resource.

15. The machine readable storage according to claim 12, wherein said processing further comprises synchronizing said sales process related information transfer between said at least one sales process and said at least one external processing resource.

16. The machine readable storage according to claim 15, wherein said synchronizing further comprises:
translating sales process related information from a first non-native format to a second native format;
validating said translated sales process related information;
staging said validated sales process related information; and
referencing said validated sales process related information to determine associations.

17. The machine readable storage according to claim 12, further comprising scheduling said processing of said acquired sales process related information.

18. The machine readable storage according to claim 17, wherein said scheduling further comprises controlling at least a frequency of said acquiring sales process related information from said at least one external processing resource.

19. The machine readable storage according to claim 12, wherein said processing of said acquired sales process related information further comprises:
detecting operational errors; and
notifying at least one of a sub-system and a system operator of said detected error.

20. The machine readable storage according to claim 19, wherein said detected operational errors comprises a plurality of severity levels.

21. The machine readable storage according to claim 12, further comprising configuring operations of at least one of said connecting, acquiring, processing, and said communicating steps.

22. The machine readable storage according to claim 12, wherein said at least one external processing resource comprises at least one of SAP, order management system (ODM), customer relationship management (CRM), document management system (DMS), learning management system (LMS) and lightweight directory access (LDAP) database.

23. A system for sales process integration, the system comprising:
a sales process integration engine, said sales process integration engine comprising:
an integration configurator;
a data synchronizer coupled to said integration configurator;
a service scheduler coupled to said integration configurator; and
a service notifier coupled to said integration configurator.

24. The system according to claim 23, wherein said data synchronizer further comprises:
an integration communication interface;
a data mapper coupled to said integration communication interface;
a data validator coupled to said integration communication interface; and
a data stager coupled to said integration communication interface.
